(19) United States
(12) Patent Application Publication
(10) Pub. No.: US 2024/0393778 A1
(43) Pub. Date: Nov. 28, 2024

(54) OPTIMIZING A TARGET AUTOMATED ECOSYSTEM USING DIGITAL TWIN SIMULATIONS

(71) Applicant: International Business Machines Corporation, Armonk, NY (US)

(72) Inventors: Tushar Agrawal, West Fargo, ND (US); Jeremy R. Fox, Georgetown, TX (US); Su Liu, Austin, TX (US); Sarbajit K. Rakshit, Kolkata (IN)

(21) Appl. No.: 18/201,711

(22) Filed: May 24, 2023

(51) Int. Cl. G05B 23/02

(52) U.S. Cl. CPC G05B 23/0259

(57) ABSTRACT

Described are techniques for optimizing a target automated ecosystem. Requirements of the target automated ecosystem are received. A digital twin simulation of one or more reference automated ecosystems implementing the requirements of the target automated ecosystem are created and executed. Furthermore, a digital twin simulation of the target automated ecosystem is created and executed to implement the requirements of the target automated ecosystem. A comparative analysis is then performed between the digital twin simulations of one or more reference automated ecosystems and the target automated ecosystem. Based on the comparative analysis, the infrastructure implemented and/or processes executed by the reference automated ecosystem(s) with an improvement over the infrastructure implemented and/or processes executed by the target automated ecosystem that exceeds a threshold value, which may be user-selected, are identified. Such identified infrastructure and/or processes are then provided to an expert to be adopted and implemented in the target automated ecosystem.

### TECHNICAL FIELD

The present disclosure relates generally to automated ecosystems, and more particularly to optimizing a target automated ecosystem using digital twin simulations of reference automated ecosystem(s) and the target automated ecosystem.

### BACKGROUND

An automated ecosystem (also referred to as a “digital ecosystem”) is a group of interconnected technology resources that can function as a unit. The automated ecosystem is comprised of machines, devices, robots, etc. as well as the software used to control such machines, devices, robots, etc. For example, an automated ecosystem may be utilized in an industrial facility, such as a plant, to assemble vehicles.

### SUMMARY

In one embodiment of the present disclosure, a computer-implemented method for optimizing a target automated ecosystem comprises receiving requirements of the target automated ecosystem. The method further comprises creating and executing a first digital twin simulation of a first reference automated ecosystem implementing the requirements of the target automated ecosystem. The method additionally comprises creating and executing a second digital twin simulation of the target automated ecosystem implementing the requirements of the target automated ecosystem. Furthermore, the method comprises performing a comparative analysis between the first and second digital twin simulations to identify differences in terms of infrastructure and processes. Additionally, the method comprises identifying a first set of infrastructure implemented and/or processes executed by the first reference automated ecosystem with an improvement over infrastructure implemented and/or processes executed by the target automated ecosystem based on the comparative analysis. In addition, the method comprises providing the first set of infrastructure and/or processes to be adopted and implemented in the target automated ecosystem.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 is a diagram of the software components used by the automated ecosystem optimizer for optimizing the target automated ecosystem in accordance with an embodiment of the present disclosure;

FIG. 3 illustrates an embodiment of the present disclosure of the hardware configuration of the automated ecosystem optimizer which is representative of a hardware environment for practicing the present disclosure; and

FIGS. 4A-4B are a flowchart of a method for optimizing a target automated ecosystem via the use of digital twin simulations in accordance with an embodiment of the present disclosure.

### DETAILED DESCRIPTION

As stated above, an automated ecosystem (also referred to as a “digital ecosystem”) is a group of interconnected technology resources that can function as a unit. The automated ecosystem is comprised of machines, devices, robots, etc. as well as the software used to control such machines, devices, robots, etc. For example, an automated ecosystem may be utilized in an industrial facility, such as a plant, to assemble vehicles.

In such an automated ecosystem, the machines, devices, robots, etc. collaborate with each other to perform various activities, such as loading and unloading parts, material handling, transferring finished parts to post-processing, drilling, welding, painting, product inspection, picking and placing, die casting, glass making, grinding, etc. Furthermore, such machines, devices, robots, etc. are controlled by software, such as automation software. Additionally, artificial intelligence systems may be utilized to control the machines, devices, robots, etc. and execute the activities using a knowledge corpus and learned behaviors. Furthermore, in an automated ecosystem, such machines, devices, robots, etc. may communicate with each other as per the workflow (processes and tasks which occur in a particular order) as well as perform activities by pre-defied rules.

Hence, the operation of an automated ecosystem is complex with an intricate infrastructure, such as an industrial floor infrastructure, executing complicated processes. An infrastructure, such as an industrial floor infrastructure, refers to the machines, devices, robots, etc. that operate in an industrial facility to manufacture and produce parts, goods, pieces, etc. The processes refer to the actions, steps or activities performed by the infrastructure to achieve a result, such as the manufacturing of a part or good.

Currently, there have been many attempts in optimizing an automated ecosystem. Unfortunately, due to the complexity of the automated ecosystem, such efforts have been unsuccessful.

The embodiments of the present disclosure provide a means for optimizing an automated ecosystem (the automated ecosystem to be optimized is referred to herein as the “target automated ecosystem”). In one embodiment, the target automated ecosystem is optimized via the use of digital twin simulations. In one embodiment, a digital twin simulation of a reference automated ecosystem is created and executed to implement the requirements of the target automated ecosystem. As discussed above, an automated ecosystem (also referred to as a “digital ecosystem”) is a group of interconnected technology resources that can function as a unit. The automated ecosystem is comprised of machines, devices, robots, etc. as well as the software used to control such machines, devices, robots, etc. For example, an automated ecosystem may be utilized in an industrial facility, such as a plant, to assemble vehicles. A “reference automated ecosystem,” as used herein, refers to an automated ecosystem with different infrastructure and processes than the target automated ecosystem but will be simulated to implement, via the digit twin simulation, the requirements of the target automated ecosystem. Such a reference automated ecosystem may correspond to the automated ecosystem of an industrial facility, which may or may not correspond to the same industry as the target automated ecosystem. For example, the reference automated ecosystem may be directed to assembling vehicles; whereas, the target automated ecosystem is directed to assembling airplanes. Furthermore, a digital twin simulation of the target automated ecosystem is created and executed to implement the requirements of the target automated ecosystem. A comparative analysis between the digital twin simulations of the reference and target automated ecosystems may then be performed in terms of infrastructure and processes. The infrastructure and/or processes executed by the reference automated ecosystem that perform better than the infrastructure and/or processes executed by the target automated ecosystem implementing the requirements of the target automated ecosystem may then be identified based on the comparative analysis. If such identified infrastructure and/or processes result in an improvement that exceeds a threshold value, which may be user-designated, then such infrastructure and/or processes may be adopted and implemented by the target automated ecosystem. In this manner, despite the complexity of automated ecosystems, the target automated ecosystem can be optimized via the use of digital twin simulations. A further discussion regarding these and other features is provided below.

In some embodiments of the present disclosure, the present disclosure comprises a method, system and computer program product for optimizing a target automated ecosystem. In one embodiment of the present disclosure, requirements of the target automated ecosystem are received, such as from the expert in designing the target automated ecosystem. The “requirements of the target automated ecosystem,” as used herein, refer to the actions in a process that are necessary to occur in order for the ecosystem to perform its assigned task, such as to assemble automobiles. For example, the requirements of the target automated ecosystem may include converting the rolls of aluminum coils into molds of a user-specified specification, utilizing a press to shape the molds into a form of a user-specified specification, welding specified parts together, painting an object with a user-specified specification, polishing the object after painting, product inspection, material handling, transferring finished parts to post-processing, drilling, picking and placing, die casting, glass making, grinding, etc. A digital twin simulation of one or more reference automated ecosystems implementing the requirements of the target automated ecosystem are created and executed. A “digital twin,” as used herein, is a virtual representation of a real-world physical asset of a system, such as the infrastructure (e.g., machines, devices, robots, etc.) in an industrial facility, which is continuously updated. A “digital twin simulation,” as used herein, is a simulation of the virtual representation of a real-world physical asset of a system, such as the infrastructure (e.g., machines, devices, robots, etc.) in an industrial facility, which is continuously updated. A “reference automated ecosystem,” as used herein, refers to an automated ecosystem with different infrastructure and processes than the target automated ecosystem but will be simulated to implement, via the digit twin simulation, the requirements of the target automated ecosystem. Such a reference automated ecosystem may correspond to the automated ecosystem of an industrial facility, which may or may not correspond to the same industry as the target automated ecosystem (the automated ecosystem to be optimized is referred to herein as the “target automated ecosystem”). Furthermore, a digital twin simulation of the target automated ecosystem is created and executed to implement the requirements of the target automated ecosystem. A comparative analysis is then performed between the digital twin simulations of one or more reference automated ecosystems and the target automated ecosystem. In one embodiment, such a comparative analysis is performed to identify differences in terms of infrastructure and processes. Based on the comparative analysis, the infrastructure implemented and/or processes executed by the reference automated ecosystem(s) with an improvement over the infrastructure implemented and/or processes executed by the target automated ecosystem that exceeds a threshold value, which may be user-selected, are identified. In one embodiment, such threshold values differ for the various infrastructure and processes. Upon identifying infrastructure implemented and/or processes executed by the reference automated ecosystem(s) with an improvement over the infrastructure implemented and/or processes executed by the target automated ecosystem that exceeds a threshold value, such identified infrastructure and/or processes are provided to an expert to be adopted and implemented in the target automated ecosystem. In this manner, despite the complexity of automated ecosystems, the target automated ecosystem can be optimized via the use of digital twin simulations.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

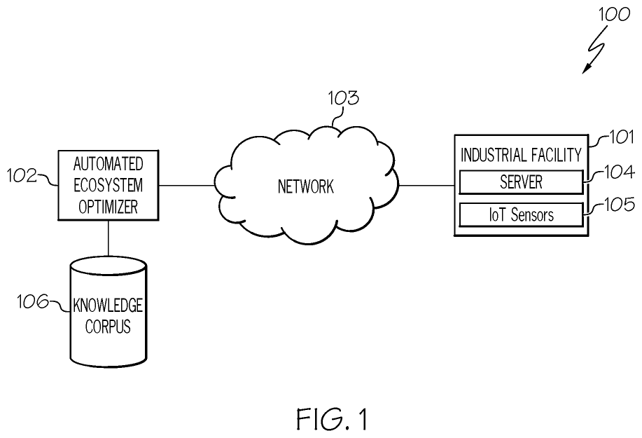

Referring now to the Figures in detail, FIG. 1 illustrates an embodiment of the present disclosure of a communication system 100 for practicing the principles of the present disclosure. Communication system 100 includes an industrial facility 101 connected to an automated ecosystem optimizer 102 via a network 103.

An “industrial facility” 101, as used herein, refers to a complex (e.g., manufacturing plant) which may consist of one or more buildings that include an infrastructure. An “infrastructure,” as used herein, refers to the machines, devices, robots, etc. that operate on the industrial floor (floor, such as concrete, used in industrial and commercial settings, such as a plant) of industrial facility 101 to manufacture and produce parts, goods, pieces, etc. For example, such an infrastructure may include robots that weld and assemble parts. In another example, such an infrastructure may include computer numerical control machines to cut metal pieces to a precise specification. In a further example, such an infrastructure may include engine machining stations used to create engine blocks.

In the illustration of FIG. 1, the interconnection of industrial facility 101 to automated ecosystem optimizer 102 via network 103 is accomplished via a server 104.

In one embodiment, server 104 stores data regarding the capabilities of the infrastructure and the automation software used to control such infrastructure. “Automation software,” as used herein, refers to applications that minimize the need for human input and are designed to turn repeatable, routine tasks into automated actions. For example, server 104 stores data regarding the capabilities of the infrastructure (e.g., machines, devices, robots, etc.) being utilized in industrial facility 101, such as loading and unloading parts, material handling, transferring finished parts to post-processing, drilling, welding, painting, product inspection, picking and placing, die casting, glass making, grinding, etc. In one embodiment, such capabilities are stored for each particular machine, device, robot, etc. of the infrastructure, such as in a data structure (e.g., table), which is stored in a storage device of server 104. Furthermore, server 104 stores data regarding the capabilities of the automation software, such as the manipulation of objects (e.g., panel) or tools (e.g., moving welding equipment along multiple axes), operations (e.g., motion control, positioning control, torque control, etc.), etc. In one embodiment, such capabilities are stored for each particular automation software being utilized, including for each version or update for such automation software, such as in a data structure (e.g., table), which is stored in a storage device of server 104.

In one embodiment, the data regarding the capabilities of the infrastructure and the automation software used to control such infrastructure is obtained and stored by server 104 from crowdsourced industries, where such information is obtained from a large group of people via the Internet, social media, smartphone applications, etc.

In one embodiment, the data regarding the capabilities of the infrastructure and the automation software used to control such infrastructure is obtained and stored by server 104 from Internet of Things (IoT) sensors 105. IoT sensor 105, as used herein, refers to a sensor that can be attached to a machine, device, robot, etc. of the infrastructure. Furthermore, IoT sensors 105 are configured to exchange data with other devices and systems over a network, such as network 103. In one embodiment, IoT sensors 105 are configured to monitor the infrastructure (e.g., machines, devices, robots, etc.) at industrial facility 101 as well as the automated software used to control such infrastructure. For example, IoT sensors 105 may monitor the capabilities of the machines, devices, robots, etc. (infrastructure), such as loading and unloading parts, material handling, transferring finished parts to post-processing, drilling, welding, painting, product inspection, picking and placing, die casting, glass making, grinding, etc. In another example, IoT sensors 105 may monitor the capabilities of the automation software, such as the manipulation of objects (e.g., panel) or tools (e.g., moving welding equipment along multiple axes), operations (e.g., motion control, positioning control, torque control, etc.), etc. Such data may then be captured by IoT sensors 105 and relayed to server 104 to be stored, such as in a storage device of server 104. Examples of such IoT sensors 105 include IoT sensors manufactured by CorSense®, Memfault, Augury®, PTC®, TE Connectivity®, etc.

In one embodiment, such data regarding the capabilities of the infrastructure and the automation software used to control such infrastructure is transmitted from industrial facility 101 to automated ecosystem optimizer 102 via network 103.

In one embodiment, automated ecosystem optimizer 102 is configured to optimize the target automated ecosystem via the use of digital twin simulations. As discussed above, the automated ecosystem is comprised of machines, devices, robots, etc. as well as the software used to control such machines, devices, robots, etc. For example, an automated ecosystem may be utilized in an industrial facility, such as a plant, to assemble automobiles. The “target automated ecosystem,” as used herein, refers to the automated ecosystem to be optimized. In one embodiment, automated ecosystem optimizer 102 optimizes the target automated ecosystem via the use of digital twin simulations. In one embodiment, automated ecosystem optimizer 102 creates and executes a digital twin simulation of a reference automated ecosystem to implement the requirements of the target automated ecosystem. A “reference automated ecosystem,” as used herein, refers to an automated ecosystem with different infrastructure and processes than the target automated ecosystem but will be simulated to implement, via the digit twin simulation, the requirements of the target automated ecosystem. Furthermore, a digital twin simulation of the target automated ecosystem is created and executed to implement the requirements of the target automated ecosystem.

In one embodiment, the results of such digital twin simulations are saved to a knowledge corpus residing in database 106 connected to automated ecosystem optimizer 102. A “knowledge corpus,” as used herein, refers to a collection of data that contains information pertaining to particular types and versions of automation software that were successfully used to control various specified capabilities of specified infrastructure (e.g., machines, devices, robots, etc.) and which specified capabilities of specified infrastructure (e.g., machines, devices, robots, etc.) were successfully controlled by which types and versions of automation software. Such a knowledge corpus may be utilized to identify a recovery schema for handling adverse effects identified from the digital twin simulations as discussed further below.

In one embodiment, automated ecosystem optimizer 102 performs a comparative analysis between the digital twin simulations of the reference and target automated ecosystems in terms of infrastructure and processes. The infrastructure and/or processes executed by the reference automated ecosystem that performs better than the infrastructure and/or processes executed by the target automated ecosystem to implement the requirements of the target automated ecosystem may then be identified based on the comparative analysis. If such identified infrastructure and/or processes result in an improvement that exceeds a threshold value, which may be user-designated, then such infrastructure and/or processes may be adopted and implemented by the target automated ecosystem.

In one embodiment, the result of such a comparative analysis is saved to a knowledge corpus residing in database 106 connected to automated ecosystem optimizer 102. Such a knowledge corpus may be utilized to identify a recovery schema for handling adverse effects identified from the digital twin simulations as discussed further below.

In this manner, despite the complexity of automated ecosystems, the target automated ecosystem can be optimized via the use of digital twin simulations. A further discussion regarding these and other features is provided below.

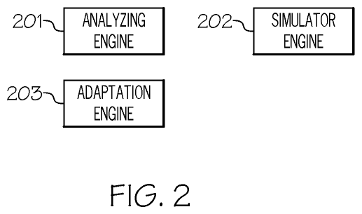

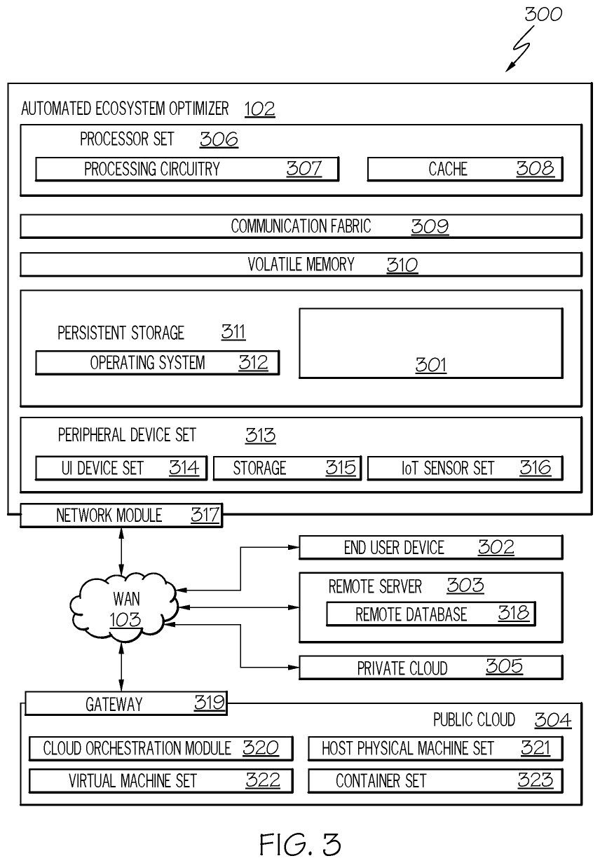

A description of the software components of automated ecosystem optimizer 102 used for optimizing the target automated ecosystem is provided below in connection with FIG. 2. A description of the hardware configuration of automated ecosystem optimizer 102 is provided further below in connection with FIG. 3.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of industrial facilities 101, automated ecosystem optimizers 102, networks 103, servers 104, IoT sensors 105 and databases 106.

A discussion regarding the software components used by automated ecosystem optimizer 102 for optimizing the target automated ecosystem is provided below in connection with FIG. 2

FIG. 2 is a diagram of the software components used by automated ecosystem optimizer 102 for optimizing the target automated ecosystem in accordance with an embodiment of the present disclosure.

Referring to FIG. 2, in conjunction with FIG. 1, automated ecosystem optimizer 102 includes analyzing engine 201 configured to perform a comparative analysis between the digital twin simulations of one or more reference automated ecosystems and the target automated ecosystem. Such comparative analysis is based on performing digital twin simulations of one or more reference automated ecosystems and the target automated ecosystem implementing the requirements of the target automated ecosystem.

In one embodiment, analyzing engine 201 receives the requirements of the target automated ecosystem from the expert in designing the target automated ecosystem. The “requirements of the target automated ecosystem,” as used herein, refer to the actions in a process that are necessary to occur in order for the ecosystem to perform its assigned task, such as assembling automobiles. For example, the requirements of the target automated ecosystem may include converting the rolls of aluminum coils into molds of a user-specified specification, utilizing a press to shape the molds into a form of a user-specified specification, welding specified parts together, painting an object with a user-specified specification, polishing the object after painting, product inspection, material handling, transferring finished parts to post-processing, drilling, picking and placing, die casting, glass making, grinding, etc.

In one embodiment, the requirements of the target automated ecosystem are identified by analyzing engine 201 via crowdsourcing, which corresponds to information obtained from a large group of people via the Internet, social media, smartphone applications, etc. For example, analyzing engine 201 receives the requirements of the target automated ecosystem based on obtaining such information from crowdsourcing directed to the purpose of the target automated ecosystem (e.g., purpose is to assemble vehicles).

Automated ecosystem analyzer 102 further includes a simulator engine 202 configured to create and execute digital twin simulations of one or more reference automated ecosystems and the target automated ecosystem implementing the requirements of the target automated ecosystem.

A “digital twin,” as used herein, is a virtual representation of a real-world physical asset of a system, such as the infrastructure (e.g., machines, devices, robots, etc.) in industrial facility 101, which is continuously updated. A “digital twin simulation,” as used herein, is a simulation of the virtual representation of a real-world physical asset of a system, such as the infrastructure (e.g., machines, devices, robots, etc.) in industrial facility 101, which is continuously updated.

In one embodiment, simulator engine 202 is configured to create a digital twin simulation of one or more reference automated ecosystems based on the infrastructure of one or more industrial facilities 101 utilizing automation software. A “reference automated ecosystem,” as used herein, refers to an automated ecosystem with different infrastructure and processes than the target automated ecosystem but will be simulated to implement, via the digit twin simulation, the requirements of the target automated ecosystem. Such a reference automated ecosystem may correspond to the automated ecosystem of an industrial facility 101, which may or may not correspond to the same industry as the target automated ecosystem. For example, the reference automated ecosystem may be directed to assembling vehicles; whereas, the target automated ecosystem is directed to assembling airplanes.

As discussed above, in one embodiment, simulator engine 202 is configured to create a digital twin simulation of a reference automated ecosystem based on the infrastructure of industrial facility 101 utilizing automation software. In one embodiment, such a digital twin simulation includes a virtual representation of the real-world infrastructure, including its capabilities, which is obtained from server 104. As previously discussed, server 104 stores data regarding the capabilities of the infrastructure and the automation software used to control such infrastructure. For example, server 104 stores data regarding the capabilities of the infrastructure (e.g., machines, devices, robots, etc.) being utilized in industrial facility 101, such as loading and unloading parts, material handling, transferring finished parts to post-processing, drilling, welding, painting, product inspection, picking and placing, die casting, glass making, grinding, etc. In one embodiment, such capabilities are stored for each particular machine, device, robot, etc. of the infrastructure, such as in a data structure (e.g., table), which is stored in a storage device of server 104. Such capabilities may then be applied to a digital copy (discussed further below).

Furthermore, simulator engine 202 creates such a digital twin simulation utilizing the capabilities of the automation software used to control such infrastructure. In one embodiment, such capabilities may be provided from server 104, which stores data regarding the capabilities of the automation software, such as the manipulation of objects (e.g., panel) or tools (e.g., moving welding equipment along multiple axes), operations (e.g., motion control, positioning control, torque control, etc.), etc. In one embodiment, such capabilities are stored for each particular automation software being utilized, including for each version or update for such automation software, such as in a data structure (e.g., table), which is stored in a storage device of server 104. In one embodiment, such capabilities of the automation software, including updates, are provided to analyzing engine 201 and/or simulator engine 202 by server 104. Such capabilities may then be applied to a digital copy (discussed further below).

In one embodiment, simulator engine 202 creates a digital twin simulation of the reference automated ecosystem(s) based on data received from sensors (e.g., IoT sensors 105) related to the vital areas of functionality and capability of the infrastructure. Such sensors 105 produce data about the different aspects of the performance of the infrastructure (e.g., machines, devices, robots, etc.). Such data is then relayed to simulator engine 202 and applied to a digital copy. A “digital copy,” as used herein, refers to a virtual copy of the physical asset, process, system and/or environment that looks like and behaves identical to its real-world counterpart. In the embodiment of the present disclosure, such a digital copy corresponds to a virtual copy of the infrastructure and automation software, such as used in industrial facility 101.

Such a digital copy is used to create a virtual model of the reference automated ecosystem(s), which is used to create and execute a digital twin simulation of the reference automated ecosystem(s) implementing the requirements of the target automated ecosystem.

In one embodiment, simulator engine 202 utilizes various software tools for creating and executing such a digital twin simulation, including, but not limited to, Vention®, aPriori® Digital Manufacturing Simulation Software, Autodesk® Digital Twin, XMPro®, Predix®, Mimic® Simulation, Ansys® Twin Builder, 7bridges, Akka®, etc.

Furthermore, simulator engine 202 creates and executes a digital twin simulation of the target automated ecosystem in the same manner as creating and executing a digital twin simulation of a reference automated ecosystem as discussed above. For example, as discussed above, simulator engine 202 obtains data pertaining to the infrastructure and automation software from a particular industrial facility 101 designated to correspond to the target automated ecosystem, which is then used to create a virtual model of the targe automated ecosystem, which is used to create and execute a digital twin simulation of the target automated ecosystem implementing the requirements of the target automated ecosystem. In one embodiment, such a target automated ecosystem may or may not correspond to the same industry as the reference automated ecosystem(s).

In one embodiment, the data pertaining to the infrastructure and automation software of industrial facility 101 designated to correspond to the target automated ecosystem is provided to simulator engine 202 by an expert developing such an ecosystem. Such data is then used by simulator engine 202 to create a virtual model of the targe automated ecosystem, which is used to create and execute a digital twin simulation of the target automated ecosystem implementing the requirements of the target automated ecosystem.

As discussed above, in one embodiment, simulator engine 202 utilizes various software tools for creating and executing such a digital twin simulation, including, but not limited to, Vention®, aPriori® Digital Manufacturing Simulation Software, Autodesk® Digital Twin, XMPro®, Predix®, Mimic® Simulation, Ansys® Twin Builder, 7bridges, Akka®, etc.

In one embodiment, simulator engine 202 stores the results of the digital twin simulations in the knowledge corpus, which resides in database 106. Such a knowledge corpus may be utilized to identify a recovery schema for handling adverse effects identified from the digital twin simulations as discussed further below.

As discussed above, analyzing engine 201 is configured to perform a comparative analysis between the digital twin simulations of one or more reference automated ecosystems and the target automated ecosystem. In one embodiment, such a comparative analysis is performed to identify differences in terms of infrastructure and processes. That is, the comparative analysis is utilized by analyzing engine 201 to identify differing capabilities of the infrastructure and/or processes.

In one embodiment, analyzing engine 201 utilizes a statistical modeling technique to derive such a comparative output. For example, in one embodiment, analyzing engine 201 utilizes correlation analysis to derive such a comparative output. Correlation analysis is a statistical method that is used to discover if there is a relationship between two variables/datasets, and how strong that relationship may be. In one embodiment, analyzing engine 201 measures various types of correlations, including Pearson correlation, Kendall rank correlation, Spearman correlation, and the Point-Biserial correlation. Examples of software tools used by analyzing engine 201 to utilize correlation analysis to derive such a comparative output, include, but not limited to, IBM® SPSS Statistics, SAS®, JMP®, Minitab®, Tableau®, Matlab®, Stata®, etc.

In another embodiment, analyzing engine 201 utilizes time series analysis to derive a comparative output. Time series analysis is a specific way of analyzing a sequence of data points collected over an interval of time. In time series analysis, such an analysis illustrates how variables change over time. Examples of software tools used by analyzing engine 201 to utilize time series analysis to derive such a comparative output, include, but not limited to, IBM® SPSS Statistics, SAS®, JMP®, Minitab®, Tableau®, Matlab®, Stata®, etc.

Examples of other statistical modeling techniques used by analyzing engine 201 for performing the comparative analysis, include, but not limited to, t-tests, analysis of variance, general linear models, etc.

In one embodiment, analyzing engine 201 utilizes IBM Cloud Pak® which produces a side-by-side comparative analysis to illustrate the delta (difference) between the ecosystems.

In one embodiment, analyzing engine 201 stores the result of the comparative analysis in the knowledge corpus, which resides in database 106. Such a knowledge corpus may be utilized to identify a recovery schema for handling adverse effects identified from the digital twin simulations as discussed further below.

In one embodiment, based on the comparative analysis, analyzing engine 201 identifies the differences between the digital twin simulations of the reference automated ecosystem(s) and the target automated ecosystem in terms of infrastructure and processes. In one embodiment, based on the comparative analysis, analyzing engine 201 identifies the infrastructure implemented and/or processes executed by the reference automated ecosystem(s) having an improvement over the infrastructure implemented and/or processes executed by the target automated ecosystem that exceeds a threshold value, which may be user-selected.

For example, suppose that one of the requirements of the target automated ecosystem is to move welding equipment along multiple axes using the welding automation software of ABB® Arc Welding FlexTrainer by ABBR. In the reference automated ecosystem, the welding equipment used corresponds to the Fanuc® ARC Mate 0iA; whereas, the welding equipment used in the target automated ecosystem is Kuka® KR Cybertech. If, according to the comparative analysis discussed above, the automation software of ABB® Arc Welding Flex Trainer by ABB® was not able to control the movement of Kuka® KR Cybertech along multiple axes, but the automation software of ABBR Arc Welding FlexTrainer by ABB® was able to control the movement of Fanuc® ARC Mate 0iA along multiple axes, then analyzing engine 201 determines that there was an improvement in utilizing the infrastructure of Fanuc® ARC Mate 0iA by the reference automated ecosystem as opposed to utilizing the infrastructure of Kuka® KR Cybertech by the target automated ecosystem. In one embodiment, such an improvement may be based on various threshold values, such as the degree of movement along the multiple axes.

In another example, suppose that one of the requirements of the target automated ecosystem is to specifically utilize the welding equipment of Fanuc® ARC Mate 0iA. Suppose further that the target automated ecosystem utilizes the automation software of version 3 of ABB® Arc Welding FlexTrainer by ABB® to control the movement of the welding equipment of Fanuc® ARC Mate 0iA along multiple axes and the reference automated ecosystem utilizes the automation software of version 4 of ABBR Arc Welding FlexTrainer by ABB® to control the movement of the welding equipment of Fanuc® ARC Mate 0iA along multiple axes. If, according to the comparative analysis discussed above, the automation software of version 3 of ABB® Arc Welding FlexTrainer by ABB® was not able to control the movement of Fanuc® ARC Mate 0iA along multiple axes, but the automation software of version 4 of ABB® Arc Welding FlexTrainer by ABB® was able to control the movement of Fanuc® ARC Mate 0iA along multiple axes, then analyzing engine 201 determines that there was an improvement in the process of utilizing version 4 of ABBR Arc Welding FlexTrainer by ABB® as opposed to utilizing version 3 of ABB® Arc Welding FlexTrainer by ABBR to control the movement of Fanuc® ARC Mate 0iA. In one embodiment, such an improvement may be based on various threshold values, such as the degree of movement along the multiple axes.

In one embodiment, such threshold values differ for the various infrastructure and processes. In one embodiment, such threshold values for the various infrastructure and processes are stored in a data structure (e.g., table), which may reside within a storage device of automated ecosystem optimizer 102. In one embodiment, such a data structure is populated by an expert.

Upon identifying such infrastructure implemented and/or processes executed by the reference automated ecosystem(s) with an improvement over the infrastructure implemented and/or processes executed by the target automated ecosystem that exceeds a threshold value, such identified infrastructure and/or processes are provided to an expert by adaptation engine 203 to be adopted and implemented in the target automated ecosystem.

In one embodiment, adaptation engine 203 is configured to provide the identified infrastructure and/or processes to be adopted and implemented in the target automated ecosystem, such as by displaying such information to the user of automated ecosystem optimizer 102 on the graphical user interface of automated ecosystem optimizer 102. In one embodiment, such a user corresponds to the expert of the target automated ecosystem, such as the individual responsible for designing the target automated ecosystem.

In one embodiment, adaptation engine 203 utilizes various software tools for providing the identified infrastructure and/or processes to be adopted and implemented in the target automated ecosystem, such as to the user of automated ecosystem optimizer 102, including, but not limited to, Pendo®, Qlik View®, Tableau®, etc.

Furthermore, in one embodiment, in addition to analyzing engine 201 identifying the differences between the digital twin simulations of the reference automated ecosystem(s) and the target automated ecosystem in terms of infrastructure and processes based on the comparative analysis, analyzing engine 201 is configured to identify the adverse effects from implementing the infrastructure and/or processes by the reference automated ecosystem(s) and the target automated ecosystem based on the digital twin simulations.

An “adverse effect,” as used herein, refers an undesired effect when implementing the requirements of the target automated ecosystem in terms of the infrastructure and/or process.

For example, suppose that one of the requirements of the target automated ecosystem is to specifically utilize the welding equipment of Fanuc® ARC Mate 0iA with movement along multiple axes. Based on the result of the digital twin simulations, it was discovered that when the welding equipment of Fanuc® ARC Mate 0iA was controlled to move along multiple axes using version 3 of ABB® Arc Welding FlexTrainer by ABB® (used by the target automated ecosystem) or version 4 of ABB® Arc Welding FlexTrainer by ABB® (used by the reference automated ecosystem) that the adverse effect of a welding failure resulted.

In one embodiment, upon identifying such adverse effects, analyzing engine 201 identifies a recovery schema for handling the identified adverse effects from the knowledge corpus discussed above. Such a knowledge corpus includes results from digital twin simulations as well as results from comparative analyses. Such knowledge may be used to identify solutions to the identified adverse effects. For example, such knowledge may be used to identify solutions for having welding failures when utilizing the equipment Fanuc® ARC Mate 0iA controlled by versions 3 and 4 of ABB® Arc Welding FlexTrainer by ABB®. For instance, such a knowledge corpus may indicate that the problem is caused by the deviation of the welding torch search position. As a result, the welding torch center point position needs to be adjusted. Hence, analyzing engine 201 identifies the recovery schema of adjusting the welding torch center point position from the knowledge corpus to address the identified adverse effect.

In one embodiment, analyzing engine 201 utilizes the k-nearest neighbors algorithm to identify such a recovery schema from the knowledge corpus. In one embodiment, the k-nearest neighbors algorithm works by finding the k nearest neighbors of a given item (e.g., capability of infrastructure, capability of automation software). The neighbors are then used to vote on the rating of the item. The algorithm then uses the average of the votes to predict the rating of the item.

In one embodiment, analyzing engine 201 identifies the recovery schema for handling the identified adverse effects from the knowledge corpus using a machine learning algorithm to build and train a model (machine learning model) to identify the recovery schema for handling the identified adverse effects from the knowledge corpus using a sample data set that includes recovery schema for handling various adverse effects from a knowledge corpus. In one embodiment, such a sample data set is compiled by an expert.

Furthermore, such a sample data set is referred to herein as the “training data,” which is used by the machine learning algorithm to make predictions or decisions as to the appropriate recovery schema to be identified for handling various adverse effects from a knowledge corpus. The algorithm iteratively makes predictions of identifying the appropriate recovery schema for handling various adverse effects from a knowledge corpus until the predictions achieve the desired accuracy as determined by an expert. Examples of such learning algorithms include nearest neighbor, Naïve Bayes, decision trees, linear regression, support vector machines and neural networks.

Upon analyzing engine 201 identifying such a recovery schema, such a recovery schema is provided to an expert by adaptation engine 203 to be adopted and implemented in the target automated ecosystem.

In one embodiment, adaptation engine 203 is configured to provide the recovery schema to be adopted and implemented in the target automated ecosystem, such as by displaying such information to the user of automated ecosystem optimizer 102 on the graphical user interface of automated ecosystem optimizer 102. In one embodiment, such a user corresponds to the expert of the target automated ecosystem, such as the individual responsible for designing the target automated ecosystem.

In one embodiment, adaptation engine 203 utilizes various software tools for providing the recovery schema to be adopted and implemented in the target automated ecosystem, such as to the user of automated ecosystem optimizer 102, including, but not limited to, Pendo®, Qlik View®, Tableau®, etc.

A further description of these and other features is provided below in connection with the discussion of the method for improving the target automated ecosystem.

Prior to the discussion of the method for improving the target automated ecosystem, a description of the hardware configuration of automated ecosystem optimizer 102 (FIG. 1) is provided below in connection with FIG. 3.

Referring now to FIG. 3, in conjunction with FIG. 1, FIG. 3 illustrates an embodiment of the present disclosure of the hardware configuration of automated ecosystem optimizer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code (computer code for improving the target automated ecosystem, which is stored in block 301) involved in performing the disclosed methods, such as improving the target automated ecosystem. In addition to block 301, computing environment 300 includes, for example, automated ecosystem optimizer 102, network 103, such as a wide area network (WAN), end user device (EUD) 302, remote server 303, public cloud 304, and private cloud 305. In this embodiment, automated ecosystem optimizer 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Automated ecosystem optimizer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically automated ecosystem optimizer 102, to keep the presentation as simple as possible. Automated ecosystem optimizer 102 may be located in a cloud, even though it is not shown in a cloud in FIG. 3. On the other hand, automated ecosystem optimizer 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto automated ecosystem optimizer 102 to cause a series of operational steps to be performed by processor set 306 of automated ecosystem optimizer 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 308 and the other storage media discussed below. The program instructions, and associated data, are accessed by processor set 306 to control and direct performance of the disclosed methods. In computing environment 300, at least some of the instructions for performing the disclosed methods may be stored in block 301 in persistent storage 311.

Communication fabric 309 is the signal conduction paths that allow the various components of automated ecosystem optimizer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In automated ecosystem optimizer 102, the volatile memory 310 is located in a single package and is internal to automated ecosystem optimizer 102, but, alternatively or additionally, the volatile memory may be distributed over multiple packages and/or located externally with respect to automated ecosystem optimizer 102.

Persistent Storage 311 is any form of non-volatile storage for computers that is now known or to be developed in the future. The non-volatility of this storage means that the stored data is maintained regardless of whether power is being supplied to automated ecosystem optimizer 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the disclosed methods.

Peripheral device set 313 includes the set of peripheral devices of automated ecosystem optimizer 102. Data communication connections between the peripheral devices and the other components of automated ecosystem optimizer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where automated ecosystem optimizer 102 is required to have a large amount of storage (for example, where automated ecosystem optimizer 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows automated ecosystem optimizer 102 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the disclosed methods can typically be downloaded to automated ecosystem optimizer 102 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates automated ecosystem optimizer 102), and may take any of the forms discussed above in connection with automated ecosystem optimizer 102. EUD 302 typically receives helpful and useful data from the operations of automated ecosystem optimizer 102. For example, in a hypothetical case where automated ecosystem optimizer 102 is designed to provide a recommendation to an end user, this recommendation would typically be communicated from network module 317 of automated ecosystem optimizer 102 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to automated ecosystem optimizer 102. Remote server 303 may be controlled and used by the same entity that operates automated ecosystem optimizer 102. Remote server 303 represents the machine(s) that collect and store helpful and useful data for use by other computers, such as automated ecosystem optimizer 102. For example, in a hypothetical case where automated ecosystem optimizer 102 is designed and programmed to provide a recommendation based on historical data, then this historical data may be provided to automated ecosystem optimizer 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to improve the target automated ecosystem. In one embodiment, such components may be implemented in hardware. The functions discussed above performed by such components are not generic computer functions. As a result, automated ecosystem optimizer 102 is a particular machine that is the result of implementing specific, non-generic computer functions.

In one embodiment, the functionality of such software components of automated ecosystem optimizer 102, including the functionality for improving the target automated ecosystem, may be embodied in an application specific integrated circuit.

As stated above, an automated ecosystem (also referred to as a “digital ecosystem”) is a group of interconnected technology resources that can function as a unit. The automated ecosystem is comprised of machines, devices, robots, etc. as well as the software used to control such machines, devices, robots, etc. For example, an automated ecosystem may be utilized in an industrial facility, such as a plant, to assemble vehicles. In such an automated ecosystem, the machines, devices, robots, etc. collaborate with each other to perform various activities, such as loading and unloading parts, material handling, transferring finished parts to post-processing, drilling, welding, painting, product inspection, picking and placing, die casting, glass making, grinding, etc. Furthermore, such machines, devices, robots, etc. are controlled by software, such as automation software. Additionally, artificial intelligence systems may be utilized to control the machines, devices, robots, etc. and execute the activities using a knowledge corpus and learned behaviors. Furthermore, in an automated ecosystem, such machines, devices, robots, etc. may communicate with each other as per the workflow (processes and tasks which occur in a particular order) as well as perform activities by pre-defied rules. Hence, the operation of an automated ecosystem is complex with an intricate infrastructure, such as an industrial floor infrastructure, executing complicated processes. An infrastructure, such as an industrial floor infrastructure, refers to the machines, devices, robots, etc. that operate in an industrial facility to manufacture and produce parts, goods, pieces, etc. The processes refer to the actions, steps or activities performed by the infrastructure to achieve a result, such as the manufacturing of a part or good. Currently, there have been many attempts in optimizing an automated ecosystem. Unfortunately, due to the complexity of the automated ecosystem, such efforts have been unsuccessful.

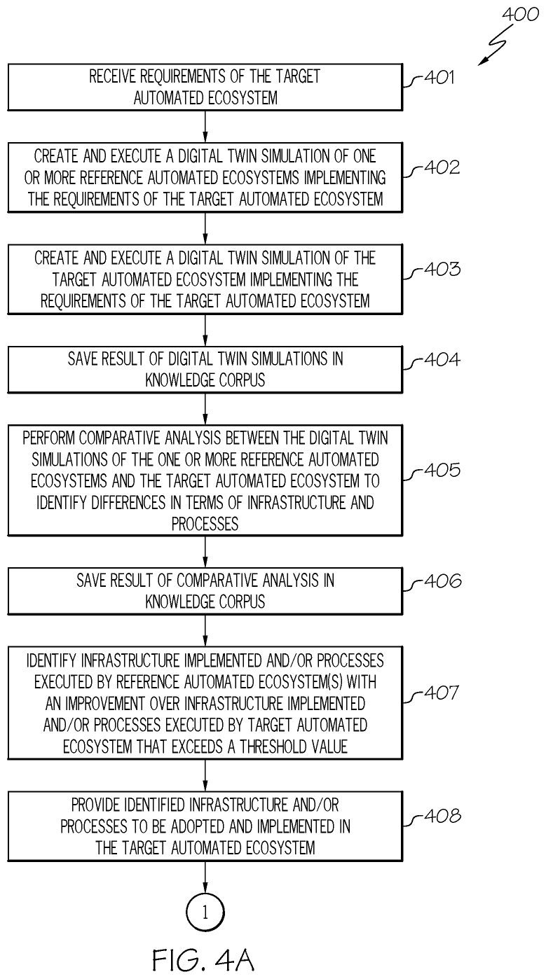

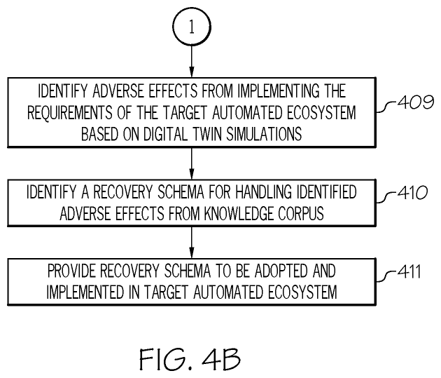

The embodiments of the present disclosure provide a means for optimizing a target automated ecosystem via the use of digital twin simulations as discussed below in connection with FIGS. 4A-4B.

FIGS. 4A-4B are a flowchart of a method 400 for optimizing a target automated ecosystem via the use of digital twin simulations in accordance with an embodiment of the present disclosure.

Referring to FIG. 4A, in conjunction with FIGS. 1-3, in operation 401, analyzing engine 201 of automated ecosystem optimizer 102 receives the requirements of the target automated ecosystem, such as from the expert in designing the target automated ecosystem. The “requirements of the target automated ecosystem,” as used herein, refer to the actions in a process that are necessary to occur in order for the ecosystem to perform its assigned task, such as assembling automobiles. For example, the requirements of the target automated ecosystem may include converting the rolls of aluminum coils into molds of a user-specified specification, utilizing a press to shape the molds into a form of a user-specified specification, welding specified parts together, painting an object with a user-specified specification, polishing the object after painting, product inspection, material handling, transferring finished parts to post-processing, drilling, picking and placing, die casting, glass making, grinding, etc.

As discussed above, in one embodiment, the requirements of the target automated ecosystem are identified by analyzing engine 201 via crowdsourcing, which corresponds to information obtained from a large group of people via the Internet, social media, smartphone applications, etc. For example, analyzing engine 201 receives the requirements of the target automated ecosystem based on obtaining such information from crowdsourcing directed to the purpose of the target automated ecosystem (e.g., purpose is to assemble vehicles).

In operation 402, simulator engine 202 of automated ecosystem optimizer 102 creates and executes a digital twin simulation of one or more reference automated ecosystems implementing the requirements of the target automated ecosystem.

As stated above, a “digital twin,” as used herein, is a virtual representation of a real-world physical asset of a system, such as the infrastructure (e.g., machines, devices, robots, etc.) in industrial facility 101, which is continuously updated. A “digital twin simulation,” as used herein, is a simulation of the virtual representation of a real-world physical asset of a system, such as the infrastructure (e.g., machines, devices, robots, etc.) in industrial facility 101, which is continuously updated.

In one embodiment, simulator engine 202 is configured to create a digital twin simulation of one or more reference automated ecosystems based on the infrastructure of one or more industrial facilities 101 utilizing automation software. A “reference automated ecosystem,” as used herein, refers to an automated ecosystem with different infrastructure and processes than the target automated ecosystem but will be simulated to implement, via the digit twin simulation, the requirements of the target automated ecosystem. Such a reference automated ecosystem may correspond to the automated ecosystem of an industrial facility 101, which may or may not correspond to the same industry as the target automated ecosystem. For example, the reference automated ecosystem may be directed to the assembling vehicles; whereas, the target automated ecosystem is directed to assembling airplanes.

As discussed above, in one embodiment, simulator engine 202 is configured to create a digital twin simulation of a reference automated ecosystem based on the infrastructure of industrial facility 101 utilizing automation software. In one embodiment, such a digital twin simulation includes a virtual representation of the real-world infrastructure, including its capabilities, which is obtained from server 104. As previously discussed, server 104 stores data regarding the capabilities of the infrastructure. For example, server 104 stores data regarding the capabilities of the infrastructure (e.g., machines, devices, robots, etc.) being utilized in industrial facility 101, such as loading and unloading parts, material handling, transferring finished parts to post-processing, drilling, welding, painting, product inspection, picking and placing, die casting, glass making, grinding, etc. In one embodiment, such capabilities are stored for each particular machine, device, robot, etc. of the infrastructure, such as in a data structure (e.g., table), which is stored in a storage device of server 104. Such capabilities may then be applied to a digital copy.

Furthermore, simulator engine 202 creates such a digital twin simulation utilizing the capabilities of automation software. In one embodiment, such capabilities may be provided from server 104, which stores data regarding the capabilities of the automation software, such as the manipulation of objects (e.g., panel) or tools (e.g., moving welding equipment along multiple axes), operations (e.g., motion control, positioning control, torque control, etc.), etc. In one embodiment, such capabilities are stored for each particular automation software being utilized, including for each version or update for such automation software, such as in a data structure (e.g., table), which is stored in a storage device of server 104. In one embodiment, such capabilities of the automation software, including updates, are provided to analyzing engine 201 and/or simulator engine 202 by server 104. Such capabilities may then be applied to a digital copy.

In one embodiment, simulator engine 202 creates a digital twin simulation of the reference automated ecosystem(s) based on data received from sensors (e.g., IoT sensors 105) related to vital areas of functionality and capability of the infrastructure. Such sensors 105 produce data about the different aspects of the performance of the infrastructure (e.g., machines, devices, robots, etc.). Such data is then relayed to simulator engine 202 and applied to a digital copy. A “digital copy,” as used herein, refers to a virtual copy of the physical asset, process, system and/or environment that looks like and behaves identical to its real-world counterpart. In the embodiment of the present disclosure, such a digital copy corresponds to a virtual copy of the infrastructure and automation software, such as used in industrial facility 101.

Such a digital copy is used to create a virtual model of the reference automated ecosystem(s), which is used to create and execute a digital twin simulation of the reference automated ecosystem(s) implementing the requirements of the target automated ecosystem.

In one embodiment, simulator engine 202 utilizes various software tools for creating and executing such a digital twin simulation, including, but not limited to, Vention®, aPriori® Digital Manufacturing Simulation Software, Autodesk® Digital Twin, XMPro®, Predix®, Mimic® Simulation, Ansys® Twin Builder, 7bridges, Akka®, etc.

In operation 403, simulator engine 202 of automated ecosystem optimizer 102 creates and executes a digital twin simulation of the target reference automated ecosystem implementing the requirements of the target automated ecosystem.

As stated above, simulator engine 202 creates and executes a digital twin simulation of the target automated ecosystem in the same manner as creating and executing a digital twin simulation of a reference automated ecosystem as discussed above. For example, as discussed above, simulator engine 202 obtains data pertaining to the infrastructure and automation software from a particular industrial facility 101 designated to correspond to the target automated ecosystem, which is then used to create a virtual model of the targe automated ecosystem, which is used to create and execute a digital twin simulation of the target automated ecosystem implementing the requirements of the target automated ecosystem. In one embodiment, such a target automated ecosystem may or may not correspond to the same industry as the reference automated ecosystem(s).

In one embodiment, the data pertaining to the infrastructure and automation software of industrial facility 101 designated to correspond to the target automated ecosystem is provided to simulator engine 202 by an expert developing such an ecosystem. Such data is then used by simulator engine 202 to create a virtual model of the targe automated ecosystem, which is used to create and execute a digital twin simulation of the target automated ecosystem implementing the requirements of the target automated ecosystem.

As discussed above, in one embodiment, simulator engine 202 utilizes various software tools for creating and executing such a digital twin simulation, including, but not limited to, Vention®, aPriori® Digital Manufacturing Simulation Software, Autodesk® Digital Twin, XMPro®, Predix®, Mimic® Simulation, Ansys® Twin Builder, 7bridges, Akka®, etc.

In operation 404, simulator engine 202 of automated ecosystem optimizer 102 saves the results of the digital twin simulations (digital twin simulations performed in operations 402, 403) in the knowledge corpus, which resides in database 106. Such a knowledge corpus may be utilized to identify a recovery schema for handling adverse effects identified from the digital twin simulations as discussed further below.

In operation 405, analyzing engine 201 of automated ecosystem optimizer 102 performs a comparative analysis between the digital twin simulations of one or more reference automated ecosystems and the target automated ecosystem. In one embodiment, such a comparative analysis is performed to identify differences in terms of infrastructure and processes. That is, the comparative analysis is utilized by analyzing engine 201 to identify differing capabilities of the infrastructure and/or processes.

As discussed above, an “infrastructure,” as used herein, refers to the machines, devices, robots, etc. that operate on the industrial floor (floor, such as concrete, used in industrial and commercial settings, such as a plant) of industrial facility 101 to manufacture and produce parts, goods, pieces, etc. For example, such an infrastructure may include robots that weld and assemble parts. In another example, such an infrastructure may include computer numerical control machines to cut metal pieces to a precise specification. In a further example, such an infrastructure may include engine machining stations used to create engine blocks.

“Processes,” as used herein, refer to the actions, steps or activities performed by the infrastructure to achieve a result, such as the manufacturing of a part or good.

As further discussed above, in one embodiment, analyzing engine 201 utilizes a statistical modeling technique to derive such a comparative output. For example, in one embodiment, analyzing engine 201 utilizes correlation analysis to derive such a comparative output. Correlation analysis is a statistical method that is used to discover if there is a relationship between two variables/datasets, and how strong that relationship may be. In one embodiment, analyzing engine 201 measures various types of correlations, including Pearson correlation, Kendall rank correlation, Spearman correlation, and the Point-Biserial correlation. Examples of software tools used by analyzing engine 201 to utilize correlation analysis to derive such a comparative output, include, but not limited to, IBM® SPSS Statistics, SAS®, JMP®, Minitab®, Tableau®, Matlab®, Stata®, etc.

In another embodiment, analyzing engine 201 utilizes time series analysis to derive a comparative output. Time series analysis is a specific way of analyzing a sequence of data points collected over an interval of time. In time series analysis, such an analysis illustrates how variables change over time. Examples of software tools used by analyzing engine 201 to utilize time series analysis to derive such a comparative output, include, but not limited to, IBM® SPSS Statistics, SAS®, JMP®, Minitab®, Tableau®, Matlab®, Stata®, etc.

Examples of other statistical modeling techniques used by analyzing engine 201 for performing the comparative analysis, include, but not limited to, t-tests, analysis of variance, general linear models, etc.

In one embodiment, analyzing engine 201 utilizes IBM Cloud Pak® which produces a side-by-side comparative analysis to illustrate the delta (difference) between the ecosystems.

In operation 406, analyzing engine 201 of automated ecosystem optimizer 102 saves the result of the comparative analysis in the knowledge corpus, which resides in database 106. Such a knowledge corpus may be utilized to identify a recovery schema for handling adverse effects identified from the digital twin simulations as discussed further below.

In operation 407, based on the comparative analysis, analyzing engine 201 identifies the infrastructure implemented and/or processes executed by the reference automated ecosystem(s) with an improvement over the infrastructure implemented and/or processes executed by the target automated ecosystem that exceeds a threshold value, which may be user-selected.

As stated above, for example, suppose that one of the requirements of the target automated ecosystem is to move welding equipment along multiple axes using the welding automation software of ABB® Arc Welding FlexTrainer by ABBR. In the reference automated ecosystem, the welding equipment used corresponds to the Fanuc® ARC Mate 0iA; whereas, the welding equipment used in the target automated ecosystem is Kuka® KR Cybertech. If, according to the comparative analysis discussed above, the automation software of ABB® Arc Welding FlexTrainer by ABB® was not able to control the movement of Kuka® KR Cybertech along multiple axes, but the automation software of ABB® Arc Welding Flex Trainer by ABB® was able to control the movement of Fanuc® ARC Mate 0iA along multiple axes, then analyzing engine 201 determines that there was an improvement in utilizing the infrastructure of Fanuc® ARC Mate 0iA by the reference automated ecosystem as opposed to utilizing the infrastructure of Kuka® KR Cybertech by the target automated ecosystem. In one embodiment, such an improvement may be based on various threshold values, such as the degree of movement along the multiple axes.

In another example, suppose that one of the requirements of the target automated ecosystem is to specifically utilize the welding equipment of Fanuc® ARC Mate 0iA. Suppose further that the target automated ecosystem utilizes the automation software of version 3 of ABB® Arc Welding Flex Trainer by ABBR to control the movement of the welding equipment of Fanuc® ARC Mate 0iA along multiple axes and the reference automated ecosystem utilizes the automation software of version 4 of ABBR Arc Welding FlexTrainer by ABB® to control the movement of the welding equipment of Fanuc® ARC Mate 0iA along multiple axes. If, according to the comparative analysis discussed above, the automation software of version 3 of ABB® Arc Welding FlexTrainer by ABB® was not able to control the movement of Fanuc® ARC Mate 0iA along multiple axes, but the automation software of version 4 of ABB® Arc Welding FlexTrainer by ABBR was able to control the movement of Fanuc® ARC Mate 0iA along multiple axes, then analyzing engine 201 determines that there was an improvement in the process of utilizing version 4 of ABBR Arc Welding FlexTrainer by ABB® as opposed to utilizing version 3 of ABB® Arc Welding FlexTrainer by ABB® to control the movement of Fanuc® ARC Mate 0iA. In one embodiment, such an improvement may be based on various threshold values, such as the degree of movement along the multiple axes.

In one embodiment, such threshold values differ for the various infrastructure and processes. In one embodiment, such threshold values for the various infrastructure and processes are stored in a data structure (e.g., table), which may reside within a storage device (e.g., storage device 311, 315) of automated ecosystem optimizer 102. In one embodiment, such a data structure is populated by an expert.

In operation 408, upon identifying infrastructure implemented and/or processes executed by the reference automated ecosystem(s) with an improvement over the infrastructure implemented and/or processes executed by the target automated ecosystem that exceeds a threshold value, adaptation engine 203 of automated ecosystem optimizer 102 provides such identified infrastructure and/or processes to be adopted and implemented in the target automated ecosystem.

As discussed above, in one embodiment, adaptation engine 203 is configured to provide the identified infrastructure and/or processes to be adopted and implemented in the target automated ecosystem, such as by displaying such information to the user of automated ecosystem optimizer 102 on the graphical user interface of automated ecosystem optimizer 102. In one embodiment, such a user corresponds to the expert of the target automated ecosystem, such as the individual responsible for designing the target automated ecosystem.

In one embodiment, adaptation engine 203 utilizes various software tools for providing the identified infrastructure and/or processes to be adopted and implemented in the target automated ecosystem, such as to the user of automated ecosystem optimizer 102, including, but not limited to, Pendo®, Qlik View®, Tableau®, etc.

Referring to FIG. 4B, in conjunction with FIGS. 1-3, in addition to analyzing engine 201 identifying the infrastructure implemented and/or processes executed by the reference automated ecosystem(s) with an improvement over the infrastructure implemented and/or processes executed by the target automated ecosystem that exceeds a threshold value, in operation 409, analyzing engine 201 of automated ecosystem optimizer 102 identifies the adverse effects from implementing the requirements of the target automated ecosystem by the one or more reference automated ecosystems and the target automated ecosystem based on the digital twin simulations (digital twin simulations of operations 402, 403).

As stated above, an “adverse effect,” as used herein, refers an undesired effect when implementing the requirements of the target automated ecosystem in terms of the infrastructure and/or process.

For example, suppose that one of the requirements of the target automated ecosystem is to specifically utilize the welding equipment of Fanuc® ARC Mate 0iA with movement along multiple axes. Based on the result of the digital twin simulations, it was discovered that when the welding equipment of Fanuc® ARC Mate 0iA was controlled to move along multiple axes using version 3 of ABB® Arc Welding FlexTrainer by ABB® (used by the target automated ecosystem) or version 4 of ABB® Arc Welding FlexTrainer by ABB® (used by the reference automated ecosystem) that the adverse effect of a welding failure resulted.

In operation 410, analyzing engine 201 of automated ecosystem optimizer 102 identifies a recovery schema for handling the identified adverse effects from the knowledge corpus.

As discussed above, such a knowledge corpus includes results from digital twin simulations as well as results from comparative analyses. Such knowledge may be used to identify solutions to the identified adverse effects. For example, such knowledge may be used to identify solutions for having welding failures when utilizing the equipment Fanuc® ARC Mate 0iA controlled by versions 3 and 4 of ABB® Arc Welding FlexTrainer by ABB®. For instance, such a knowledge corpus may indicate that the problem is caused by the deviation of the welding torch search position. As a result, the welding torch center point position needs to be adjusted. Hence, analyzing engine 201 identifies the recovery schema of adjusting the welding torch center point position from the knowledge corpus to address the identified adverse effect.

In one embodiment, analyzing engine 201 utilizes the k-nearest neighbors algorithm to identify such a recovery schema from the knowledge corpus. In one embodiment, the k-nearest neighbors algorithm works by finding the k nearest neighbors of a given item (e.g., capability of infrastructure, capability of automation software). The neighbors are then used to vote on the rating of the item. The algorithm then uses the average of the votes to predict the rating of the item.

In one embodiment, analyzing engine 201 identifies the recovery schema for handling the identified adverse effects from the knowledge corpus using a machine learning algorithm to build and train a model (machine learning model) to identify the recovery schema for handling the identified adverse effects from the knowledge corpus using a sample data set that includes recovery schema for handling various adverse effects from a knowledge corpus. In one embodiment, such a sample data set is compiled by an expert.

Furthermore, such a sample data set is referred to herein as the “training data,” which is used by the machine learning algorithm to make predictions or decisions as to the appropriate recovery schema to be identified for handling various adverse effects from a knowledge corpus. The algorithm iteratively makes predictions of identifying the appropriate recovery schema for handling various adverse effects from a knowledge corpus until the predictions achieve the desired accuracy as determined by an expert. Examples of such learning algorithms include nearest neighbor, Naïve Bayes, decision trees, linear regression, support vector machines and neural networks.

In operation 411, upon analyzing engine 201 identifying such a recovery schema, adaptation engine 203 of automated ecosystem optimizer 102 provides such a recovery schema, such as to an expert, to be adopted and implemented in the target automated ecosystem.

As stated above, in one embodiment, adaptation engine 203 is configured to provide the recovery schema to be adopted and implemented in the target automated ecosystem, such as by displaying such information to the user of automated ecosystem optimizer 102 on the graphical user interface of automated ecosystem optimizer 102. In one embodiment, such a user corresponds to the expert of the target automated ecosystem, such as the individual responsible for designing the target automated ecosystem.

In one embodiment, adaptation engine 203 utilizes various software tools for providing the recovery schema to be adopted and implemented in the target automated ecosystem, such as to the user of automated ecosystem optimizer 102, including, but not limited to, Pendo®, Qlik View®, Tableau®, etc.

As a result of the foregoing, the target automated ecosystem is optimized via the use of digital twin simulations, such as the digital twin simulations of one or more reference automated ecosystems and the target automated ecosystem.

Furthermore, the principles of the present disclosure improve the technology or technical field involving automated ecosystems. As discussed above, an automated ecosystem (also referred to as a “digital ecosystem”) is a group of interconnected technology resources that can function as a unit. The automated ecosystem is comprised of machines, devices, robots, etc. as well as the software used to control such machines, devices, robots, etc. For example, an automated ecosystem may be utilized in an industrial facility, such as a plant, to assemble vehicles. In such an automated ecosystem, the machines, devices, robots, etc. collaborate with each other to perform various activities, such as loading and unloading parts, material handling, transferring finished parts to post-processing, drilling, welding, painting, product inspection, picking and placing, die casting, glass making, grinding, etc. Furthermore, such machines, devices, robots, etc. are controlled by software, such as automation software. Additionally, artificial intelligence systems may be utilized to control the machines, devices, robots, etc. and execute the activities using a knowledge corpus and learned behaviors. Furthermore, in an automated ecosystem, such machines, devices, robots, etc. may communicate with each other as per the workflow (processes and tasks which occur in a particular order) as well as perform activities by pre-defied rules. Hence, the operation of an automated ecosystem is complex with an intricate infrastructure, such as an industrial floor infrastructure, executing complicated processes. An infrastructure, such as an industrial floor infrastructure, refers to the machines, devices, robots, etc. that operate in an industrial facility to manufacture and produce parts, goods, pieces, etc. The processes refer to the actions, steps or activities performed by the infrastructure to achieve a result, such as the manufacturing of a part or good. Currently, there have been many attempts in optimizing an automated ecosystem. Unfortunately, due to the complexity of the automated ecosystem, such efforts have been unsuccessful.

Embodiments of the present disclosure improve such technology by receiving the requirements of the target automated ecosystem, such as from the expert in designing the target automated ecosystem. The “requirements of the target automated ecosystem,” as used herein, refer to the actions in a process that are necessary to occur in order for the ecosystem to perform its assigned task, such as to assemble automobiles. For example, the requirements of the target automated ecosystem may include converting the rolls of aluminum coils into molds of a user-specified specification, utilizing a press to shape the molds into a form of a user-specified specification, welding specified parts together, painting an object with a user-specified specification, polishing the object after painting, product inspection, material handling, transferring finished parts to post-processing, drilling, picking and placing, die casting, glass making, grinding, etc. A digital twin simulation of one or more reference automated ecosystems implementing the requirements of the target automated ecosystem are created and executed. A “digital twin,” as used herein, is a virtual representation of a real-world physical asset of a system, such as the infrastructure (e.g., machines, devices, robots, etc.) in an industrial facility, which is continuously updated. A “digital twin simulation,” as used herein, is a simulation of the virtual representation of a real-world physical asset of a system, such as the infrastructure (e.g., machines, devices, robots, etc.) in an industrial facility, which is continuously updated. A “reference automated ecosystem,” as used herein, refers to an automated ecosystem with different infrastructure and processes than the target automated ecosystem but will be simulated to implement, via the digit twin simulation, the requirements of the target automated ecosystem. Such a reference automated ecosystem may correspond to the automated ecosystem of an industrial facility, which may or may not correspond to the same industry as the target automated ecosystem (the automated ecosystem to be optimized is referred to herein as the “target automated ecosystem”). Furthermore, a digital twin simulation of the target automated ecosystem is created and executed to implement the requirements of the target automated ecosystem. A comparative analysis is then performed between the digital twin simulations of one or more reference automated ecosystems and the target automated ecosystem. In one embodiment, such a comparative analysis is performed to identify differences in terms of infrastructure and processes. Based on the comparative analysis, the infrastructure implemented and/or processes executed by the reference automated ecosystem(s) with an improvement over the infrastructure implemented and/or processes executed by the target automated ecosystem that exceeds a threshold value, which may be user-selected, are identified. In one embodiment, such threshold values differ for the various infrastructure and processes. Upon identifying infrastructure implemented and/or processes executed by the reference automated ecosystem(s) with an improvement over the infrastructure implemented and/or processes executed by the target automated ecosystem that exceeds a threshold value, such identified infrastructure and/or processes are provided to an expert to be adopted and implemented in the target automated ecosystem. In this manner, despite the complexity of automated ecosystems, the target automated ecosystem can be optimized via the use of digital twin simulations. Furthermore, in this manner, there is an improvement in the technical field involving automated ecosystems.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for optimizing a target automated ecosystem, the method comprising:
receiving requirements of the target automated ecosystem;
creating and executing a first digital twin simulation of a first reference automated ecosystem implementing the requirements of the target automated ecosystem;
creating and executing a second digital twin simulation of the target automated ecosystem implementing the requirements of the target automated ecosystem;
performing a comparative analysis between the first and second digital twin simulations to identify differences in terms of infrastructure and processes;
identifying a first set of infrastructure implemented and/or processes executed by the first reference automated ecosystem with an improvement over infrastructure implemented and/or processes executed by the target automated ecosystem based on the comparative analysis; and
providing the first set of infrastructure and/or processes to be adopted and implemented in the target automated ecosystem.

2. The method as recited in claim 1 further comprising:
identifying the first set of infrastructure implemented and/or processes executed by the first reference automated ecosystem with an improvement over infrastructure implemented and/or processes executed by the target automated ecosystem that exceeds a threshold value.

3. The method as recited in claim 1 further comprising:
saving a result of the first and second digital twin simulations in a knowledge corpus; and
saving a result of the comparative analysis in the knowledge corpus.

4. The method as recited in claim 3 further comprising:
identifying adverse effects from implementing the requirements of the target automated ecosystem by the first reference automated ecosystem and the target automated ecosystem based on the first and second digital twin simulations.

5. The method as recited in claim 4 further comprising:
identifying a recovery schema for handling the identified adverse effects from the knowledge corpus.

6. The method as recited in claim 5 further comprising:
providing the recovery schema to be adopted and implemented in the target automation ecosystem.

7. The method as recited in claim 1 further comprising:
creating and executing a third digital twin simulation of a second reference automated ecosystem implementing the requirements of the target automated ecosystem;
performing the comparative analysis between the first, second and third digital twin simulations to identify differences in terms of infrastructure and processes; and 5
identifying a second set of infrastructure implemented and/or processes executed by the first and second reference automated ecosystems with an improvement over infrastructure implemented and/or processes executed by the target automated ecosystem; and
providing the second set of infrastructure and/or processes to be adopted and implemented in the target automated ecosystem.

8. A computer program product for optimizing a target automated ecosystem, the computer program product comprising one or more computer readable storage mediums having program code embodied therewith, the program code comprising programming instructions for:
receiving requirements of the target automated ecosystem;
creating and executing a first digital twin simulation of a first reference automated ecosystem implementing the requirements of the target automated ecosystem;
creating and executing a second digital twin simulation of the target automated ecosystem implementing the requirements of the target automated ecosystem;
performing a comparative analysis between the first and second digital twin simulations to identify differences in terms of infrastructure and processes;
identifying a first set of infrastructure implemented and/or processes executed by the first reference automated ecosystem with an improvement over infrastructure implemented and/or processes executed by the target automated ecosystem based on the comparative analysis; and
providing the first set of infrastructure and/or processes to be adopted and implemented in the target automated ecosystem.

9. The computer program product as recited in claim 8, wherein the program code further comprises the programming instructions for:
identifying the first set of infrastructure implemented and/or processes executed by the first reference automated ecosystem with an improvement over infrastructure implemented and/or processes executed by the target automated ecosystem that exceeds a threshold value.

10. The computer program product as recited in claim 8, wherein the program code further comprises the programming instructions for:
saving a result of the first and second digital twin simulations in a knowledge corpus; and
saving a result of the comparative analysis in the knowledge corpus.

11. The computer program product as recited in claim 10, wherein the program code further comprises the programming instructions for:
identifying adverse effects from implementing the requirements of the target automated ecosystem by the first reference automated ecosystem and the target automated ecosystem based on the first and second digital twin simulations.

12. The computer program product as recited in claim 11, wherein the program code further comprises the programming instructions for:

identifying a recovery schema for handling the identified adverse effects from the knowledge corpus.

13. The computer program product as recited in claim 12, wherein the program code further comprises the programming instructions for:
providing the recovery schema to be adopted and implemented in the target automation ecosystem.

14. The computer program product as recited in claim 8, wherein the program code further comprises the programming instructions for:
creating and executing a third digital twin simulation of a second reference automated implementing the requirements of the target automated ecosystem;
performing the comparative analysis between the first, second and third digital twin simulations to identify differences in terms of infrastructure and processes; and
identifying a second set of infrastructure implemented and/or processes executed by the first and second reference automated ecosystems with an improvement over infrastructure implemented and/or processes executed by the target automated ecosystem; and
providing the second set of infrastructure and/or processes to be adopted and implemented in the target automated ecosystem.

15. A system, comprising:
a memory for storing a computer program for optimizing a target automated ecosystem; and
a processor connected to the memory, wherein the processor is configured to execute program instructions of the computer program comprising:
receiving requirements of the target automated ecosystem;
creating and executing a first digital twin simulation of a first reference automated ecosystem implementing the requirements of the target automated ecosystem;
creating and executing a second digital twin simulation of the target automated ecosystem implementing the requirements of the target automated ecosystem;
performing a comparative analysis between the first and second digital twin simulations to identify differences in terms of infrastructure and processes;
identifying a first set of infrastructure implemented and/or processes executed by the first reference automated ecosystem with an improvement over infrastructure implemented and/or processes executed by the target automated ecosystem based on the comparative analysis; and
providing the first set of infrastructure and/or processes to be adopted and implemented in the target automated ecosystem.

16. The system as recited in claim 15, wherein the program instructions of the computer program further comprise:
identifying the first set of infrastructure implemented and/or processes executed by the first reference automated ecosystem with an improvement over infrastructure implemented and/or processes executed by the target automated ecosystem that exceeds a threshold value.

17. The system as recited in claim 15, wherein the program instructions of the computer program further comprise:
saving a result of the first and second digital twin simulations in a knowledge corpus; and
saving a result of the comparative analysis in the knowledge corpus.

18. The system as recited in claim 17, wherein the program instructions of the computer program further comprise:
identifying adverse effects from implementing the requirements of the target automated ecosystem by the first reference automated ecosystem and the target automated ecosystem based on the first and second digital twin simulations.

19. The system as recited in claim 18, wherein the program instructions of the computer program further comprise:
identifying a recovery schema for handling the identified adverse effects from the knowledge corpus.

20. The system as recited in claim 19, wherein the program instructions of the computer program further comprise:
providing the recovery schema to be adopted and implemented in the target automation ecosystem.
